(19) United States
(12) Patent Application Publication
(10) Pub. No.: US 2008/0011118 A1
(43) Pub. Date: Jan. 17, 2008

(54) Steering Wheel for a Motor Vehicle

(76) Inventors: Dirk Meissner, Berlin (DE); Dieter Markfort, Berlin (DE)

Correspondence Address: FITCH EVEN TABIN AND FLANNERY, 120 SOUTH LA SALLE STREET, SUITE 1600, CHICAGO, IL, 60603-3406, US

(21) Appl. No.: 11/687,362

(22) Filed: Mar. 16, 2007

Related U.S. Application Data
(63) Continuation of application No. PCT/DE05/01665, filed on Sep. 19, 2005.

(30) Foreign Application Priority Data
Sep. 17, 2004 (DE) 102004046321.2

(51) Int. Cl. G05G 1/10

(52) U.S. Cl. 74/555

(57) ABSTRACT

A steering wheel for a motor vehicle is provided comprising a steering wheel base body for placing said steering wheel on the motor vehicle, a steering wheel rim connected to the steering wheel base body and an adjusting mechanism which is used for adjusting the steering wheel rim, in particular the inclination thereof with respect to the steering wheel base body and comprises drive means for inducing an adjusting force into the steering wheel rim in order to adjust the inclination thereof. According to one form, at least one interface is arranged between the drive means and the steering wheel rim, wherein two steering wheel components disposed between said drive means and the steering wheel rim for force distribution are tiltable with respect to each other on said interface.

### CROSS REFERENCE TO RELATED APPLICATIONS

This is a continuation application of prior application number PCT/DE2005/001665, filed Sep. 19, 2005 and claims the benefit under 35 U.S.C. §119 of prior foreign application number DE 10 2004 046 321.2, filed Sep. 17, 2004.

### FIELD OF THE INVENTION

The invention relates to a steering wheel for a motor vehicle.

### BACKGROUND OF THE INVENTION

A steering wheel of this type comprises a steering wheel basic body (steering wheel carcass) for mounting the steering wheel on a motor vehicle, in particular via a hub provided on the steering wheel basic body; a steering wheel rim which is connected to the steering wheel basic body and at which the steering wheel can be grasped in order to carry out a steering movement; and an adjusting mechanism for setting the position of the steering wheel rim with respect to the steering wheel basic body, with which the inclination of the steering wheel rim can be set with respect to the steering wheel basic body and which comprises driving means for introducing an adjusting force into the steering wheel rim in order to be able to set the inclination thereof with respect to the steering wheel basic body. In this case, the adjusting mechanism does not have to act directly on the steering wheel rim; on the contrary, it may also act on a component of the steering wheel that is coupled to the steering wheel rim, such as, for example, on connecting elements in the form of spokes via which the steering wheel rim is connected to the steering wheel carcass.

In the case of a steering wheel of this type known from DE 197 01 503 C1, the steering wheel rim comprises a plurality of separate rim parts which are connected to one another via an elastic steering wheel casing and which are in each case arranged an adjusting mechanism with a hydraulic piston-cylinder unit as the adjusting drive. By means of joint adjustment of the individual rim parts of the steering wheel rim with respect to the steering rim carcass—by means of the respectively assigned adjusting drive—the distance of the steering wheel rim from the steering wheel carcass can thereby be set along the steering axis about which the steering wheel rim can be rotated in order to carry out a steering movement. Furthermore, by means of the assigned adjusting drives, the individual rim parts can also be adjusted by a different amount with respect to the steering wheel carcass, which permits a setting of the inclination of the steering wheel rim with respect to the steering wheel carcass. The different adjustability of the individual rim parts with respect to the steering wheel carcass is made possible here by the fact that the rim parts can be adjusted independently of one another and are connected to one another via an adequately elastic casing. The known steering wheel requires a multi-part construction of the steering wheel rim and a correspondingly complicated design of the casing of the steering wheel rim.

### SUMMARY OF THE INVENTION

The invention is based on the problem of further improving a steering wheel of the type mentioned at the beginning.

This problem is solved according to the invention by the provision of a steering wheel with the features as described hereinafter.

According thereto, at least one interface is arranged between the driving means of the adjusting mechanism and the steering wheel rim and acts in such a manner that at the interface two components of the steering wheel that are situated in the force flux between the driving means and the steering wheel rim can be tilted with respect to each other.

The solution according to the invention permits an adjustment of the inclination of a steering wheel rim with respect to the steering wheel basic body without a complicated, multi-part construction of the steering wheel rim being required for this; on the contrary, the steering wheel rim can have, in a simple manner, an integral, continuous steering wheel rim skeleton.

The setting of the inclination of the steering wheel rim with respect to the steering wheel basic body can be achieved by the distance of the steering wheel rim being changed with respect to the steering wheel basic body, with at least two different sections of the steering wheel rim being adjustable relative to each other with respect to their distance from the steering wheel basic body, and this relative movement of the at least two sections of the steering wheel rim being made possible or being compensated for by a tilting movement at the at least one interface between steering wheel rim and the assigned driving means.

According to a preferred embodiment of the invention, the steering wheel rim is connected to the steering wheel basic body via at least one connecting element, preferably via a plurality of connecting elements, in the form of at least one spoke, and the respective connecting element is preferably of longitudinally displaceable, in particular telescopic design, for example by a first section of the connecting element being mounted displaceably on a second section of the connecting element. This permits an (infinitely variable) adjustment of the inclination of the steering wheel rim with respect to the steering wheel basic body by the length of the individual connecting elements being set differently.

On the other hand, by means of a joint adjustment of all of the connecting elements by the same amount, a re-setting of the distance of the steering wheel rim (parallel to the steering axis) from the steering wheel basic body can also be undertaken overall without the inclination, i.e. the angular position, of the steering wheel rim changing with respect to the steering wheel body.

According to a preferred embodiment of the invention, the driving means of the adjusting mechanism act on the at least one connecting element in order to permit a re-setting of the inclination of the steering wheel rim.

If a plurality of connecting elements are provided via which the steering wheel rim is connected to the steering wheel basic body, then the driving means preferably comprise a plurality of adjusting drives of which each is assigned to one of the connecting elements, in particular is arranged in or on one of the connecting elements in each case in order to be able to act on the particular connecting element and to be able to adjust it in its length, for example.

According to an embodiment of the invention, the interface at which two components of the steering wheel are coupled to each other in such a manner that they can be tilted relative to each other is provided in a manner such that it acts between the driving means and the at least one connecting element, with, in particular, one interface in each case acting between each adjusting drive and the respectively assigned connecting element.

According to another embodiment of the invention, the interface acts between two sections of a particular connecting element, with the result that two sections of the connecting element form the components of the steering wheel that can be tilted relative to one another at the interface.

According to a further embodiment of the invention, the interface acts or lies between the or each connecting element and the steering wheel rim, so that, in order to set the inclination of the steering wheel rim, the latter can be tilted relative to the or each connecting element. In this case, the interface acts, in particular, between the steering wheel rim skeleton and the skeleton of the or each connecting element.

A particular interface here can advantageously be formed by an articulated region between the relevant components of the steering wheel, for example in the form of an elastically deformable region. According to one embodiment, said region can be formed by a separate, elastic element which connects the two components of the steering wheel to each other. On the other hand, however, the interface may also be formed by an adequately elastic casing of the steering wheel. The last-mentioned exemplary embodiment has the additional advantage that a decoupling of the vibrations between those components of the steering wheel which are coupled mechanically via the interface is achieved to a particular extent. It is therefore advantageously combinable with further possibilities for forming an interface, for example an interface in the form of a material weakening or a joint between the two components of the steering wheel.

A respective adjusting drive of the driving means can be formed by a spindle mechanism, by a toothed wheel mechanism, in particular with a longitudinally displaceable rack, or by a piston-cylinder unit.

In addition to the possibility of setting the inclination and, if appropriate, the distance of the steering wheel rim with respect to the steering wheel basic body or steering wheel carcass, provision can be made for the steering wheel basic body to have means for engaging in a guide device along which the steering wheel basic body together with the steering wheel rim can be moved, so that the position of the steering wheel overall, i.e. of the steering wheel subassembly comprising steering wheel rim and steering wheel basic body and the associated connecting elements, can be changed, for example for a height adjustment of the steering wheel with respect to the vehicle floor.

According to a variant of the invention, the adjusting mechanism with which the inclination and, if appropriate, the distance of the steering wheel rim can be set with respect to the steering wheel basic body can be triggered by an actuating mechanism for ease of setting.

According to a further variant of the invention, the adjusting mechanism for setting the inclination and/or the distance of the steering wheel rim with respect to the steering wheel basic body can be activated by means of crash electronics or pre-crash electronics in order, in or before a crash situation, to trigger a movement of the steering wheel rim, for example a movement in the direction of the vehicle driver, and/or, when the vehicle driver impacts against the steering wheel rim (including an indirect impact via an airbag deployed in front of the steering wheel rim), in order to dissipate energy. This can take place, for example, by the fact that, after the impact of a vehicle driver against the steering wheel rim, an active adjustment of the steering wheel rim in the direction of the steering wheel basic body is brought about in order to absorb at least part of the impact energy of the vehicle driver. As an alternative or in addition, it can be provided that, in the event of a crash, when a vehicle driver impacts against the steering wheel rim, the adjusting mechanism permits a passive adjustment of the steering wheel rim in the direction of the steering wheel basic body in order to absorb impact energy.

The configuration according to the invention of a steering wheel can be combined with an airbag module which is arranged on the steering wheel in such a manner that the position of the airbag module is not changed during a steering movement of the steering wheel about its steering axis (what is referred to as “fixed airbag module”). For this purpose, the airbag module is to be fastened to a part of the motor vehicle that cannot be rotated together with the steering wheel. Of course, however, the steering wheel according to the invention can also be combined with an airbag module which is arranged on the steering wheel in such a manner that it is rotated about the steering axis during a steering movement.

Further details and advantages of the invention will become clear in the description below of exemplary embodiments with reference to the figures.

### BRIEF DESCRIPTION OF THE DRAWINGS

FIG. 1A shows a longitudinally adjustable steering wheel for a motor vehicle, with steering wheel rim and spokes via which the steering wheel rim is connected in a longitudinally displaceable manner to a steering wheel basic body, at a medium length setting;

FIG. 1B shows the steering wheel from FIG. 1A at a maximum length setting;

FIG. 1C shows the steering wheel from FIG. 1A at a minimum length setting;

FIG. 2A shows the steering wheel, which is additionally adjustable in inclination, according to FIG. 1A, at a neutral inclination setting;

FIG. 2B shows the steering wheel from FIG. 2A at a maximum inclination setting;

FIGS. 3A to 3D show different possibilities for forming an interface between the steering wheel rim and the spokes of the steering wheel from FIGS. 2A and 2B;

FIG. 4A shows a modification of the steering wheel from FIG. 2A at a neutral inclination setting;

FIG. 4B shows the steering wheel from FIG. 4A at a differing inclination setting;

FIG. 5 shows a possibility for forming an interface between an adjusting drive and a spoke of the steering wheel from FIG. 4;

FIG. 6 shows a steering wheel according to one of the preceding exemplary embodiments with a fixed airbag module;

FIG. 7A shows a steering wheel according to one of the preceding exemplary embodiments, which can be displaced along a guide device; and

FIGS. 7B and 7C show the steering wheel from FIG. 7A in different positions on the guide device.

### DETAILED DESCRIPTION OF THE PREFERRED EMBODIMENTS

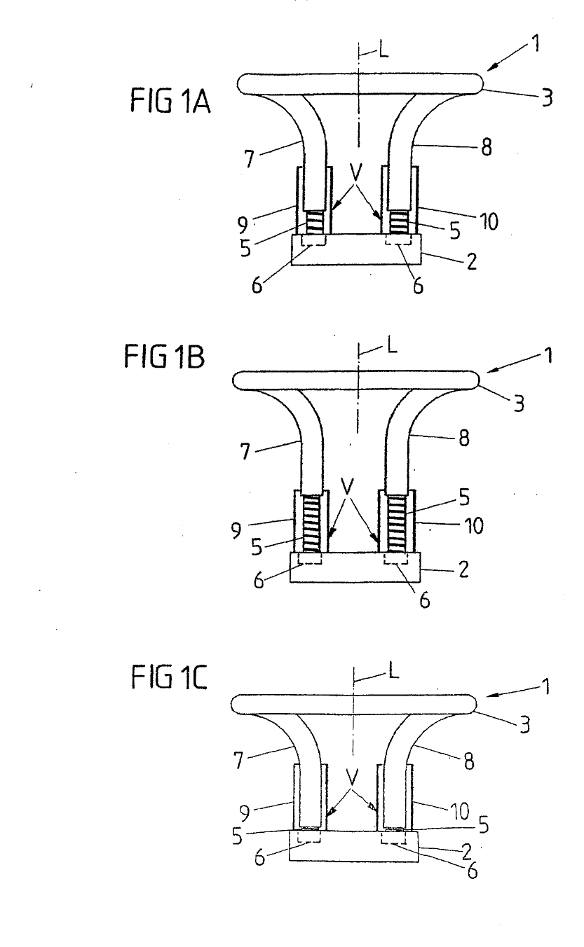

FIGS. 1A, 1B and 1C illustrate a steering wheel 1 which has a steering wheel basic body (steering wheel carcass) in the form of a plate-like steering wheel base 2 for mounting the steering wheel on a vehicle, and a steering wheel rim 3 connected to the steering wheel base 2. A first connecting element in the form of a first spoke 7, 9 and a second connecting element in the form of a second spoke 8, 10, which are in each case of length-changeable, namely telescopic, design, are arranged on the steering wheel rim 3. For this purpose, a first spoke section 7 of a first spoke 7, 9 engages in a second spoke section 9 of the first spoke, which spoke section is arranged on the steering wheel base 2 and protrudes approximately vertically from the steering wheel base 2. Similarly, a first section 8 of a second spoke 8, 10 engages in a second section 10 of the second spoke, which section is likewise arranged on the steering wheel base 2. In this case, the first and second sections of the first spoke 7, 9 and the first and second sections of the second spoke 8, 10 are in each case mounted movably with respect to one another.

In this case, a hub region is formed in a known manner on the steering wheel basic body 2 (steering wheel carcass) in the form of a steering wheel base, with which hub region the steering wheel 1 can be mounted on a steering column (steering rod or steering spindle) of a motor vehicle in a manner such that it can rotate about a steering axis L.

Displacement of the first spoke section 7 in relation to the second spoke section 9 of the first spoke 7, 9 and of the first spoke section 8 in relation to the second spoke section 10 of the second spoke 8, 10 makes it possible for the distance of the steering wheel rim 3 to be changed in its position in relation to the steering wheel base 2 (length adjustment).

The steering wheel 1 which is illustrated in FIG. 1A is situated in a semi-extended position, with the free ends of the first spoke section 7 of the first spoke 7, 9 and of the first spoke section 8 of the second spoke 8, 10, which ends are remote from the steering wheel rim 3, in each case being in a central position within the second spoke sections 9, 10 of the first and second spokes.

In the case of the steering wheel 1 illustrated in FIG. 1, the positioning of the steering wheel rim 3 with respect to the steering wheel base 2 is achieved by an adjusting mechanism V which has two adjusting drives 5, 6 as driving means. The adjusting drives 5, 6 are designed in each case as spindle drives with a rotatably mounted spindle 5, the spindle thread of which engages in the internal thread in each case of a nut 6 fixed on the steering wheel base. For this purpose, a spindle drive of this type is arranged in each case in the second spoke sections 9, 10 of the first spoke 7, 9 and second spoke 8, 10.

The spindle nuts 6 are secured on the steering wheel base 2 of the steering wheel 1 in such a manner that they can neither rotate nor move in the axial direction of the respective adjusting drive 5, 6 in the form of a spindle drive. As an alternative to the fixing of the spindle nuts 6 on the steering wheel base 2, the latter may also be fixed on the respective second spoke section 9 or 10 of the corresponding spoke 7, 9; 8, 10, to be precise preferably at the free end of the respective second spoke section 9 or 10 that is assigned to the steering wheel rim L.

By contrast, the spindles 5 not only mounted rotatably in the respectively assigned spindle nut 6 but they are also simultaneously movable in the axial direction. Furthermore, each of the two spindles 5 is connected to the first spoke section 7 or 8 of the first spoke 7, 9 or second spokes 8, 10 of the steering wheel 1 in such a manner that it carries along the respective spoke section 7, 8 during a movement in the axial direction. Since the axial direction of the adjusting drives 5, 6 in the form of spindle drives coincides with the steering axis L, a movement of the respective spindle 5 in the axial direction can cause the associated spoke section 7 or 9 of the respective spoke 7, 9 or 8, 10 to be displaced in the direction of the steering axis L, as a result of which the distance of the steering wheel rim 3 from the steering wheel base 2 can be set in an infinitely variable manner. In this case, the spindles 5 are in each case arranged within the second spoke section 9, 10 of the associated spoke 7, 9 or 8, 10.

FIG. 1B shows the steering wheel 1, which is illustrated in FIG. 1A, in a maximally extended position which, starting from the position shown in FIG. 1A, is achieved by displacing the first spoke section 7 of the first spoke 7, 9 and the first spoke section 8 of the second spoke 8, 10 away from the steering wheel basic body 2, the positional displacement as described above being achieved by an adjusting mechanism V which comprises, as driving means, two adjusting drives 5, 6 in the form of spindle drives which are in each case assigned to one of the two spokes 7, 9; 8, 10. In the embodiment shown here, all of the sections of the steering wheel rim 3 are simultaneously displaced by the same distance from the steering wheel base 2, as a result of which the displacement of the steering wheel rim 3 takes place parallel to the steering wheel base 2 (longitudinal displacement), so that here, as a result, a longitudinal adjustment of the steering wheel rim 3 with respect to the steering wheel base 2 takes place along the steering axis L.

FIG. 1C shows a position in which the first spoke section 7 of the first spoke 7, 9, which spoke section is arranged on the steering wheel rim 3, and the first spoke section 8 of the second spoke 8, 10 have been moved to the greatest possible extent into the respective second spoke sections 9, 10 of the first and second spokes 7, 9; 8, 10 in the direction of the steering wheel base 2 by means of the adjusting mechanism V comprising two adjusting drives 5, 6, which corresponds to a minimum extension of the steering wheel rim 3 with respect to the steering wheel base 2.

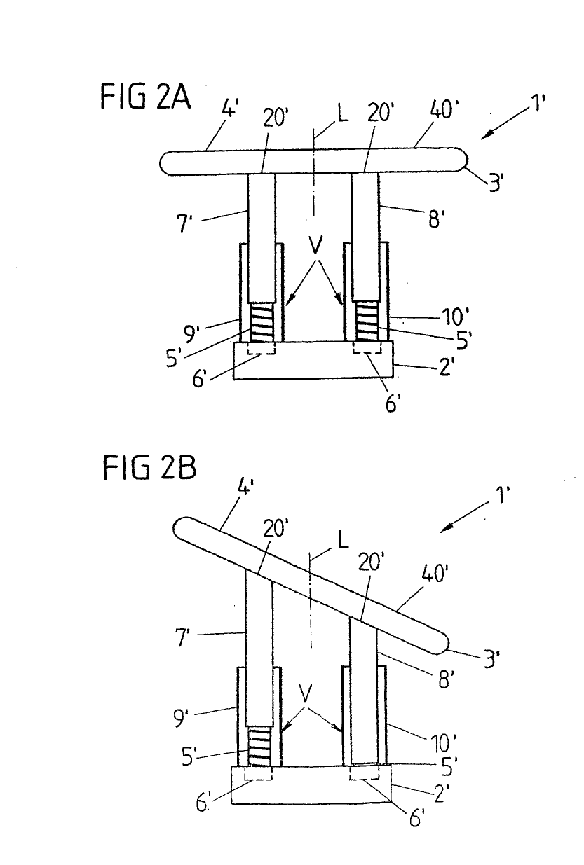

The adjusting mechanism described can be used not only as shown in FIG. 1 for the longitudinal adjustment of a steering wheel rim but can be used at the same time for adjusting the inclination of the steering wheel rim 3 with respect to the steering wheel base 2. Such an adjustment of the inclination is illustrated in FIGS. 2A and 2B.

FIGS. 2A and 2B show a steering wheel 1′ with a first spoke 7′, 9′, which is arranged on a steering wheel rim 3′, and a second spoke 8′, 10′, which spokes each have spoke sections which can be adjusted with respect to one another. For the adjustability of the spoke sections with respect to one another by means of an adjusting mechanism V comprising two adjusting drives 5′, 6′, reference is made to the description of FIGS. 1A and 1B. The steering wheel rim 3′ of the steering wheel 1′ shown has a first section 4′ and a second section 40′ which are connected fixedly (rigidly) to each other via a steering wheel rim skeleton, with the first spoke 7′, 9′ acting on the first section 40′ and the second spoke 8′, 10′ acting on the second section 40′.

In the case of the steering wheel 1′ shown in FIG. 2A, the first section 4′ and the second section 40′ of the steering wheel rim 3′ are at the same distance from the steering wheel base 2′.

In this case, the first spoke section 7′ of the first spoke 7′, 9′ and the first spoke section 8′ of the second spoke 8′, 10′ are in each case situated in a central position within the second spoke sections 9′, 10′, which corresponds to that position of the spokes which is shown in FIG. 1A.

By means of the adjusting drives 5′, 6′ which are assigned to the two spokes 7′, 9′ and 8′, 10′ of the steering wheel 1′ and are in the form in each case of a spindle drive, not only can the length of the two spokes 7′, 9′ and 8′, 10′ be adjusted together for a longitudinal displacement, as explained with reference to FIGS. 1A to 1C, but also a different length setting of the two spokes 7′, 9′, on the one hand, and 8′, 10′, on the other hand, can be undertaken. In the present case, a setting is illustrated with reference to FIG. 2B, in which, starting from the position of the steering wheel rim 3′ from FIG. 2A, the length of the first spoke 7′, 9′ remains unchanged in the steering direction L but the length of the second spoke 8′, 10′ has been reduced by the assigned spindle drive 5′, 6′. As a result, the distance of the second section 40′ of the steering wheel rim from the steering wheel base 2′ is shortened whereas, at the same time, the distance of the first section 4′ with respect to the steering wheel base 2′ is not changed, since the length of the first spoke 7′, 9′ remains unchanged. As a result, the angular position of the steering wheel 1′ that is shown in FIG. 2B can be set, which corresponds to a change in the inclination (angular position) of the steering wheel rim 3′ with respect to the steering wheel base 2′.

In order to permit the adjustment of inclination described here of the steering wheel rim 3′ with respect to the steering wheel base 2′, the first spoke section 7′, 8′ of the respective spoke 7′, 9′ or 8′, 10′ is arranged on the assigned section 4′ or 40′ of the steering wheel rim 3′ in a manner such that it can be tilted via an interface 20′.

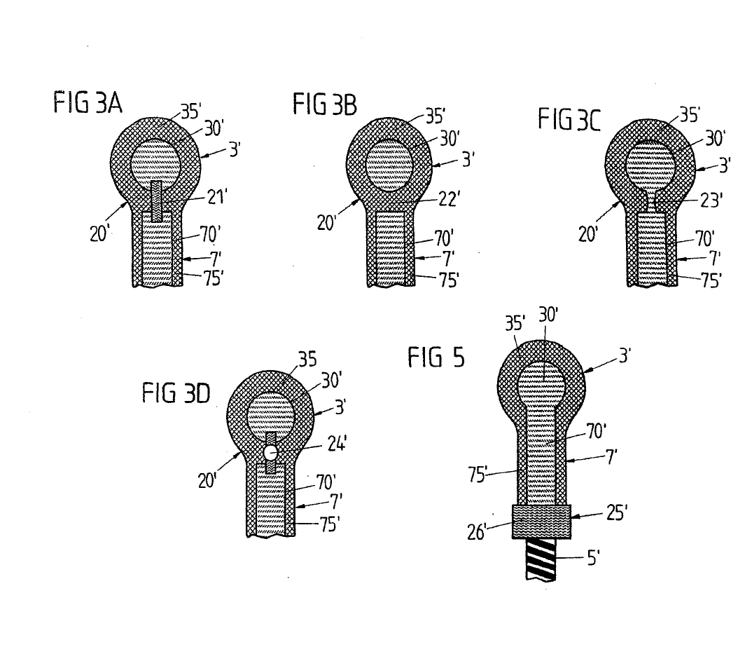

FIGS. 3A-3D illustrate different possibilities for forming an interface 20′ between the steering wheel rim 3′ and the respective first spoke section 7′ or 8′ of the respectively assigned spoke 7′, 9′ or 8′, 10′, to be precise using the example of an interface 20′ between the steering wheel rim 3′ and the first spoke section 7′ of the first spoke 7′, 9′.

According to FIG. 3A, the steering wheel rim 3′ is formed by a steering wheel rim skeleton 30′ encircling it annularly and a casing 35′, for example in the form of a foam cladding of the steering wheel skeleton, which completely engages around the steering wheel skeleton 30′. In a corresponding manner, the associated spoke or its first section 7′ has a spoke skeleton 70′ and an assigned casing 75′ in the form of a foam cladding which can be formed as a single piece with the casing 35′ of the steering wheel rim skeleton 30′.

The steering wheel rim skeleton 30′ and the spoke skeleton 70′ are connected here via an elastic element 21′ which is embedded in the casing 35′, 75′ and forms an interface 20′ which permits a tilting of the steering wheel rim skeleton 30′ and therefore of the steering wheel rim 3′ as a whole with respect to the spoke skeleton 70′ and therefore of the corresponding spoke 7′, 9′ (compare FIGS. 2A and 2B) as a whole.

FIG. 3B shows a modification of the interface 20′ from FIG. 3A, in which the casing 35′, 75′ of the steering wheel rim skeleton 3′ and of the spoke skeleton 70′ is formed in an adequately elastic manner in the region 22′ between the steering wheel rim skeleton 30′ and the spoke skeleton 70′ in order to permit a tilting of the steering wheel rim skeleton 30′ and therefore of the steering wheel rim 3′ with respect to the spoke skeleton 70′ and therefore the corresponding spoke section 7′.

In the case of the exemplary embodiment illustrated in FIG. 3C, the steering wheel rim skeleton 30′ and the spoke skeleton 70′ are connected to each other via a skeleton region having a material weakening 23′ so as to permit a tilting of the steering wheel rim skeleton 30′ with respect to the spoke skeleton 70′ in order to form an interface 20′.

Finally, in FIG. 3D, in order to form an interface 20′ between the steering wheel rim skeleton 30′ and the spoke skeleton 70′, a joint 24′ is arranged in the form of a ball-and-socket joint.

Of the embodiments illustrated in FIGS. 3A to 3D for forming an interface 20′ between the steering wheel rim 3′ and an assigned spoke section 7′, the embodiment shown in FIG. 3B has the advantage that the formation of a particularly elastic region 22′ of the steering wheel casing 35′, 75′ between steering wheel rim skeleton 30′ and spoke skeleton 70′ at the same time brings about a substantial decoupling of vibrations between the steering wheel rim 3′ and the corresponding spoke section 7′. The formation of an elastic region 22′ of the steering wheel casing between steering wheel rim skeleton 30′ and spoke skeleton 70′ can therefore advantageously and additionally also be provided in the case of the exemplary embodiments shown in FIGS. 3A, 3C and 3D, i.e. in combination with the means 21′, 23′ and 24′ respectively illustrated there in order to form an interface 20′. In this case, the elasticity or flexibility of the elastic section 22′ of the steering wheel casing 35′, 75′ is to be selected in such a manner that, in normal steering operation, it ensures an adequate transmission of torque between steering wheel rim 3′ and the corresponding spoke section 7′. If appropriate, the steering wheel casing 35′, 75′ as a whole may also be formed such that it is adequately elastic.

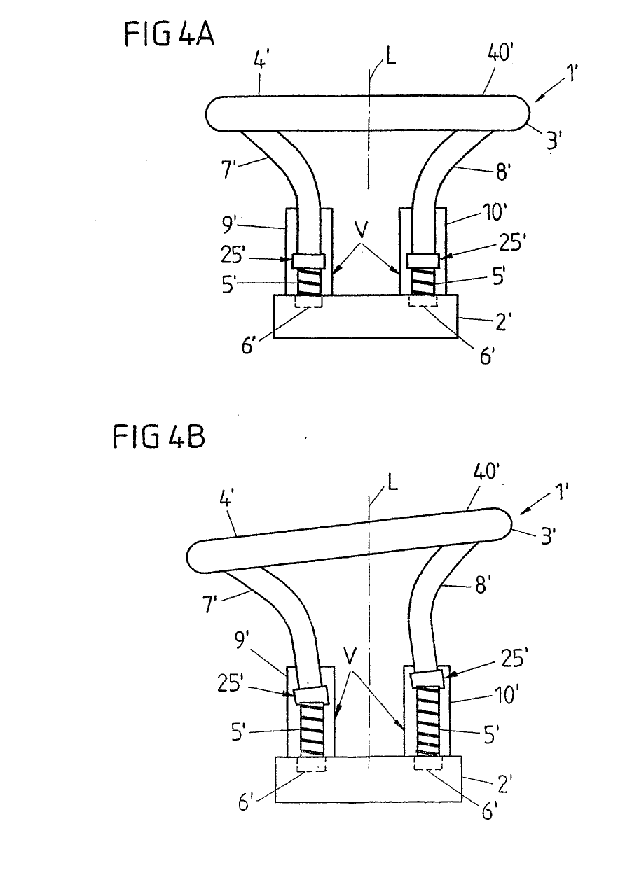

FIGS. 4A and 4B illustrate a modification of the exemplary embodiment from FIGS. 2A and 2B, the difference consisting in the fact that here, in order to compensate for an adjustment of the inclination of the steering wheel rim 3′ with respect to the steering wheel base 2′, corresponding to the transition from FIG. 4A to FIG. 4B, an interface is not provided between the spokes 7′, 9′; 8′, 10′ and the steering wheel rim 3′ but rather between the respective adjusting drive 5′, 6′ and the respective spoke 7′, 9′ or 8′, 10′, more precisely between the spindle 5′ of the respective adjusting drive 5′, 6′ and the first spoke section 7′ or 8′ of the respective spoke 7′, 9′; 8′, 10′. The design of the corresponding interface 25′ will be explained in more detail below with reference to FIG. 5.

According to FIG. 5, which corresponds in its illustration to FIGS. 3A to 3D, the steering wheel rim skeleton 30′ and the assigned spoke skeleton 70′ of a first spoke section 7′ are connected rigidly to each other. In order to form an interface 25′ between the first spoke section 7′ and the spindle 5′ of the associated adjusting drive, the spindle 5′ here is coupled at its free end, which faces the first spoke section 7′, to that spoke section 7′ via an articulated region, for example an elastically deformable element 26′ or a joint.

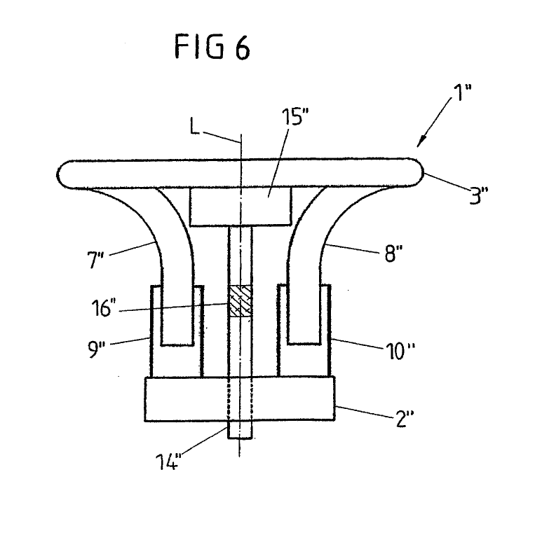

FIG. 6 shows a further embodiment of the steering wheel according to the invention, with an airbag module 15″ additionally being arranged on the steering wheel 1″. For the function of the adjusting mechanism, only part of which is shown in this figure, reference is made to the above description of FIGS. 1A to 5.

The airbag module 15″ shown in FIG. 6 is connected by means of a retaining element 14″ to a part of the vehicle that does not rotate with the steering wheel 1″. The retaining element 14″ is guided through the steering wheel base 2″ in such a manner that the position of the airbag module 15″ is not changed during a rotational movement of the steering wheel 1″ about a steering axis L. The angle of rotation of the airbag module 15″ is therefore constant with respect to the steering axis L and is therefore independent of the rotational movement of the steering wheel 1″.

So that the position of the airbag module 15″ can be matched to different settings of the inclination (angular positions) of the steering wheel rim 3″ with respect to the steering wheel base 2″, an articulated region 16″, in particular in the form of an elastic region, is provided at a suitable point in the retaining element 14″, which is extended along the steering axis L.

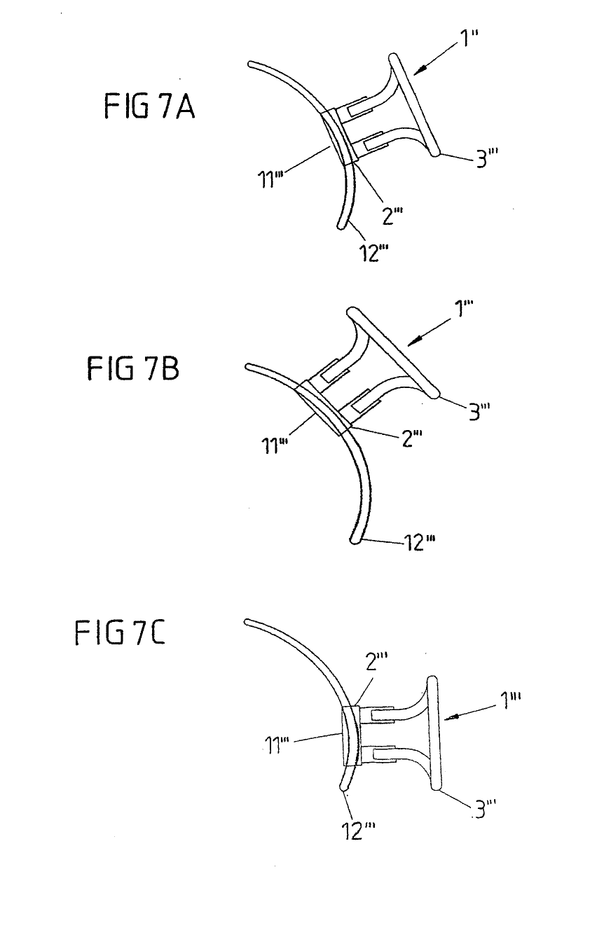

FIGS. 7A-7C illustrate a steering wheel which, in the same manner as the steering wheels described with reference to FIGS. 1A to 5, has a means of adjusting it longitudinally and in inclination but this is not shown specifically in FIGS. 7Aa to 7C. Furthermore, the steering wheel illustrated here can be adjusted in its entirety, i.e. including its steering wheel basic body—or steering wheel base 2′″ and its steering wheel rim 3′″, in its position in the vehicle.

For this additional adjustment, an element 11′″ for engaging in a guide device 12′″ provided on the vehicle is arranged on the steering wheel base 2′″ of the steering wheel 1′″, with, in an advantageous embodiment of the invention, the guide device 12′″ being formed as a slotted guide. This slotted guide forms a guide which runs essentially in the vertical direction. The element 11′″ engaging in the slotted guide can therefore be displaced within the slotted guide, so that the steering wheel as a whole can be adjusted in its position with respect to the vehicle floor in order to permit an additional matching of the position of the steering wheel to the requirements of different drivers (height adjustment).

FIG. 4A shows an embodiment of a steering wheel 1′″ on a guide device 12′″, in the form of a slotted guide, which follows the contour of the instrument panel of the vehicle. In this case, the element 11′″ provided on the steering wheel base 2′″ engages in the slotted guide and can be displaced in this guide. The displacement of the element 11′″ along the slotted guide enables the distance of the steering wheel 1′″ from the floor of the motor vehicle to be changed and the position of the steering wheel 1′″ to be matched to the height of the vehicle driver.

FIG. 4B shows the steering wheel 1′″ in a position in which the distance of the steering wheel 1′″ from the floor of the vehicle is greater than in the position shown in FIG. 4A whereas, in the position shown in FIG. 4C, the steering wheel 1′″ is at a small distance from the floor of the vehicle. By displacement of the element 11′″ arranged in the slotted guide 12′″, the steering wheel 1′″ can be transferred in an infinitely variable manner into the desired position.

The steering wheel according to the invention can be fastened in the interior of a vehicle via a part of the steering wheel basic body 2′″, for example via a hub. In particular, the steering wheel base can be fastened to a steering column (steering rod or steering spindle) in a conventional manner by means of a hub. However, the invention is not restricted to vehicles with a steering column; on the contrary, the invention can also be used in vehicles without a steering column.

In an advantageous development of the invention, an electric actuating mechanism is furthermore arranged on the steering wheel and can be used by the vehicle driver to trigger the respective adjusting mechanism and to match the position of the steering wheel to his individual requirements.

Furthermore, the adjustable steering wheel described can be used, in the event of a crash, to absorb at least part of the impact energy of a vehicle driver. For this purpose, at least one adjusting mechanism for adjusting the position of the steering wheel can be activated by crash electronics in conjunction with a pre-crash sensor or crash sensor in such a manner that the steering wheel rim of the steering wheel is moved in each case in the direction of the vehicle driver.

When a pre-crash sensor is used, the steering wheel rim of the steering wheel can already be moved in the direction of the vehicle driver before the actual crash. For this purpose, a potential accident can be detected, for example, by means of a distance sensor and, if the distance of the vehicle from an object situated outside the vehicle drops below a defined distance limit value, the adjusting mechanism of the steering wheel can be triggered. When a crash sensor is used, the adjustment of the steering wheel is not triggered until the actual crash. Then, when the vehicle driver strikes against the steering wheel, the steering wheel rim is pushed back in the direction of the steering wheel base, as a result of which the movement of the vehicle driver in the direction of the windshield is retarded.

In a development of the invention, in conjunction with a pre-crash sensor or crash sensor for adjusting the position of the steering wheel in the event of a (potential) crash, the force produced by a driver striking against the steering wheel, in particular the steering wheel rim, is measured. If a defined limit value of this force is exceeded, the steering wheel rim is actively adjusted in the direction of the steering wheel base by means of the adjusting mechanism. As a result, injuries to the vehicle driver can be avoided.

What is claimed is:

1. A steering wheel for a motor vehicle, with
a steering wheel basic body for mounting the steering wheel on a motor vehicle,
a steering wheel rim connected to the steering wheel basic body, and
an adjusting mechanism for setting the position of the steering wheel rim, with which the inclination of the steering wheel rim with respect to the steering wheel basic body can be set and which comprises driving means for introducing an adjusting force into the steering wheel rim in order to be able to adjust the inclination thereof,
characterized in that
at least one interface is arranged between the driving means and the steering wheel rim, at which two components of the steering wheel that are situated in the force flux between the driving means and the steering wheel rim can be tilted with respect to each other.

2. The steering wheel as claimed in claim 1, characterized in that the distance of the steering wheel rim from the steering wheel basic body can be changed by the setting of the inclination of the steering wheel rim with respect to the steering wheel basic body, with at least two sections of the steering wheel rim being adjusted relative to each other in their distance from the steering wheel basic body.

3. The steering wheel as claimed in claim 1, characterized in that at least one connecting element for connecting to the steering wheel basic body is provided on the steering wheel rim.

4. The steering wheel as claimed in claim 3, characterized in that the connecting element is designed as a spoke.

5. The steering wheel as claimed in claim 3, characterized in that a plurality of connecting elements are provided for connecting the steering wheel rim to the steering wheel basic body.

6. The steering wheel as claimed in claim 3, characterized in that at least one connecting element is of length-changeable design.

7. The steering wheel as claimed in claim 6, characterized in that the connecting element is of telescopic design.

8. The steering wheel as claimed in claim 6, characterized in that, to connect the steering wheel rim to the steering wheel basic body, a first section of the connecting element is mounted displaceably on a second section of the connecting element.

9. The steering wheel as claimed in claim 6, characterized in that the connecting element can be adjusted in its length in an infinitely variable manner.

10. The steering wheel as claimed in claim 3, characterized in that the driving means of the adjusting mechanism act on the at least one connecting element.

11. The steering wheel as claimed in claim 5, characterized in that an adjusting drive of the driving means acts on each connecting element.

12. The steering wheel as claimed in claim 10, characterized in that an adjusting drive of the driving means is arranged in or on each connecting element.

13. The steering wheel as claimed in claim 3, characterized in that the interface is arranged between the driving means and the at least one connecting element.

14. The steering wheel as claimed in claim 11, characterized in that a respective interface is arranged between each adjusting drive and the assigned connecting element.

15. The steering wheel as claimed in claim 3, characterized in that the interface is arranged between two sections of the at least one connecting element.

16. The steering wheel as claimed in claim 3, characterized in that the interface is arranged between the at least one connecting element and the steering wheel rim.

17. The steering wheel as claimed in claim 16, characterized in that the interface acts between a steering wheel rim skeleton and a skeleton of the connecting element.

18. The steering wheel as claimed in claim 1, characterized in that the interface is formed by an articulated region between two components of the steering wheel.

19. The steering wheel as claimed in claim 18, characterized in that the articulated region is designed as an elastically deformable region.

20. The steering wheel as claimed in claim 18, characterized in that the articulated region is formed by a separate, elastic element.

21. The steering wheel as claimed in claim 18, characterized in that the articulated region is formed by a material weakening.

22. The steering wheel as claimed in claim 18, characterized in that an elastic region of a casing of the steering wheel is provided at the interface, said region permitting a relative tilting of components of the steering wheel that are situated on both sides of the elastic region of the casing.

23. The steering wheel as claimed in claim 18, characterized in that the interface has a joint.

24. The steering wheel as claimed in claim 1, characterized in that the driving means comprise a spindle mechanism.

25. The steering wheel as claimed in claim 1, characterized in that the driving means comprise a piston-cylinder unit.

26. The steering wheel as claimed in claim 1, characterized in that the driving means comprise a toothed wheel mechanism, in particular a rack mechanism.

27. The steering wheel as claimed in claim 1, characterized in that the steering wheel basic body is designed as a steering wheel base.

28. The steering wheel as claimed in claim 1, characterized in that the steering wheel is mounted on the motor vehicle by means of a hub region provided on the steering wheel basic body.

29. The steering wheel as claimed in claim 1, characterized in that the adjusting mechanism can additionally be used to set the distance of the steering wheel rim from the steering wheel basic body at a constant inclination of the steering wheel rim.

30. The steering wheel as claimed in claim 1, characterized in that, to adjust the position of the entire steering wheel along a guide device, the steering wheel basic body has an element for engaging in the guide device.

31. The steering wheel as claimed in claim 1, characterized in that the adjusting mechanism can be triggered manually by means of an actuating mechanism.

32. The steering wheel as claimed in claim 1, characterized in that, in the event of a crash, the adjusting mechanism serves to absorb at least part of the impact energy of a vehicle driver by the adjusting mechanism, before the impact of a vehicle driver, bringing about a movement of the steering wheel rim toward the vehicle driver.

33. The steering wheel as claimed in claim 32, characterized in that the adjusting mechanism for adjusting the steering wheel can be activated by means of pre-crash electronics and/or crash electronics.

34. The steering wheel as claimed in claim 1, characterized in that, in the event of a crash, when a vehicle driver impacts against the steering wheel rim, the adjusting mechanism brings about an active adjustment of the steering wheel rim in the direction of the steering wheel basic body in order to absorb at least part of the impact energy of the vehicle driver.

35. The steering wheel as claimed in claim 1, characterized in that, in the event of a crash, when a vehicle driver impacts against the steering wheel rim, the adjusting mechanism permits a passive adjustment of the steering wheel rim in the direction of the steering wheel basic body in order to absorb at least part of the impact energy of the vehicle driver.

36. The steering wheel as claimed in claim 1, characterized by an airbag module which is arranged on the steering wheel in such a manner that the position of the airbag module is not changed during a rotational movement of the steering wheel about a steering axis.

37. The steering wheel as claimed in claim 36, characterized in that the airbag module can be fastened to a part of the vehicle that does not rotate with the steering wheel.
